(19) United States
(12) Patent Application Publication
(10) Pub. No.: US 2021/0069550 A1
(43) Pub. Date: Mar. 11, 2021

(54) AUTONOMOUS ATHLETE DATA CORRELATION

(71) Applicant: CSR Lab, LLC, Dover, DE (US)

(72) Inventors: Christopher M. Clark, Morristown, TN (US); Stephen E. Johnson, Brick, NJ (US); Robert J. Corsi, Eatontown, NJ (US)

(73) Assignee: CSR Lab, LLC, Dover, DE (US)

(21) Appl. No.: 16/948,182

(22) Filed: Sep. 8, 2020

Related U.S. Application Data
(60) Provisional application No. 62/898,150, filed on Sep. 10, 2019.

(51) Int. Cl. A63B 24/00; G06K 9/00; A63B 71/06

(52) U.S. Cl. CPC A63B 24/0062; G06K 9/00724; A63B 71/0622; A63B 2102/18; A63B 2071/0638; A63B 2220/05; A63B 24/0003

(57) ABSTRACT

A method for correlating performance data in regard to a performance of a user, by capturing a first data stream in regard to the performance on a first device, capturing a second data stream in regard to the performance on a second device, uploading a first video of the first data stream to a correlation device, uploading a second video of the second data stream to the correlation device, using machine vision on the correlation device extract first performance data from the first video and second performance data from the second video, associating the first performance data with the second performance data to create correlated performance data on the correlation device, and enabling access to the correlated performance data to authorized users on the correlation device.

### PRIORITY

This application claims all rights and priority on prior pending U.S. provisional patent application Ser. No. 62/898,150 filed 2019 Sep. 10.

### FIELD

This invention relates to the field of athlete performance data. More particularly, this invention relates to gathering and analyzing such data from a variety of different sources.

### INTRODUCTION

The market for athlete training and performance tracking has dramatically increased. Network-connected personal devices such as smartphones are used to host applications that track athlete performance changes over time for activities such as swinging a bat, throwing a ball, running, or shooting a basketball. Many such applications store historical data that can be compared to current data, thus showing how performance has changed over time.

However, in many situations there is a completely different device that tracks another component of the activity. For example, tracking the flight of the ball that is thrown by the pitcher, or of the ball that is hit by the batter or the golfer. When analyzing the mechanical movement of an athlete, the outcome of the movement is often a separate but important parameter to track. If one device is tracking the mechanics of the swing but can't correlate that to the flight of the ball, then an important component of performance analysis and improvement is missing.

One way to correlate such data is for the athlete or some third party to record all such data by hand, either on a piece of paper or in a spreadsheet, as it is gathered from various sources after each event. However, stopping and restarting the athletic activity so as to record the data in this manner tends to impede or completely stop the real time aspect of the activity that is so often required during training or competition. Even if it is a third party who is doing the recording, if the athlete has to wait until the data from the various sources is recorded, then the purpose of the training activity or competition can still be lost. Further, the manual entry of such data creates opportunities for human error than can lead to incorrect analysis results and sub-optimal training.

What is needed, therefore, is a system that tends to reduce issues such as those described above, at least in part.

### SUMMARY

The above and other needs are met by a method for correlating performance data in regard to a performance of a user, by capturing a first data stream in regard to the performance on a first device, capturing a second data stream in regard to the performance on a second device, uploading a first video of the first data stream to a correlation device, uploading a second video of the second data stream to the correlation device, using machine vision on the correlation device extract first performance data from the first video and second performance data from the second video, associating the first performance data with the second performance data to create correlated performance data on the correlation device, and enabling access to the correlated performance data to authorized users on the correlation device.

In various embodiments according to this aspect of the invention, at least one of the first data stream and the second data stream comprises a video of the performance. In some embodiments, at least one of the first data stream and the second data stream comprises telemetry in regard to objects with which the user interacts during the performance. In some embodiments, at least one of the first data stream and the second data stream comprises physiological data in regard to the user during the performance. In some embodiments, at least one of the first data stream and the second data stream comprises at least one of bat speed, bat arc, and bat angle. In some embodiments, at least one of the first data stream and the second data stream comprises at least one of ball speed, ball rotation, and ball trajectory.

According to another aspect of the invention, there is described a method for capturing performance data in regard to a performance of a user, by displaying a first data stream in regard to the performance on a first device, capturing in a first video the display of the first data stream, uploading the first video to a correlation device, using machine vision on the correlation device, extracting first performance data from the first video, and enabling access to the first performance data to authorized users on the correlation device.

In various embodiments according to this aspect of the invention, the first data stream comprises telemetry in regard to objects with which the user interacts during the performance. In some embodiments, the first data stream comprises physiological data in regard to the user during the performance. In some embodiments, the first data stream comprises at least one of bat speed, bat arc, and bat angle. In some embodiments, the first data stream comprises at least one of ball speed, ball rotation, and ball trajectory.

### DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is a functional block diagram of a system according to an embodiment of the present invention.

FIG. 2 is a schematic block diagram of a computing apparatus according to an embodiment of the present invention.

### DESCRIPTION

### General Overview

Various embodiments according to the present invention create a link between different software programs and application by use of what is called herein a passive visual interface (PVI). In some embodiments, the PVI is created by a screen capture or recording routine, if the device on which the information is presented supports such an operation. In other embodiments, the PVI is created by use of a camera that is directed at the screen of the device that is presenting the data. This mode is beneficial when the device doesn't have the ability to record the data presentation on the screen.

The information that is presented on the screen of the device can come from a variety of different sources, as explained in some of the examples below. In some embodiments the information comes from a sensor that is in data communication with the device. In other embodiments the data is generated within the device itself. In other embodiments the data is generated from a video stream.

In various embodiments, the user-athlete's personal electronic device is the central device to which other hardware devices (generally referred to as sensors herein) connect or otherwise provide their data. In the embodiments described herein, the example of a smartphone is used, but it is appreciated that other personal electronic devices, such as a tablet or personal digital assistant or wearable device, are also comprehended herein.

Many sensors have wireless communication, such as Bluetooth, and are associated with applications that can be loaded onto the user's smartphone, such as through an application store, such as iTunes and Google Play. In addition, many smartphones have a built-in ability to selectively record whatever is displayed on the screen of the smartphone, such as by recording a video of the phone screen.

The user can then record the screen of his smartphone while the application associated with these sensors (that are tracking the training data) are running on the smartphone. The video of the recorded screen contains a record of all the data collected during the session from a given sensor. Instead of the user manually recording the data after each event and disrupting the flow of the training or performance event, he can use the screen record feature to record a video of the smartphone screen, and then upload the screen record video to a server that extracts the desired data from the recording of the event. This same thing can be done for each of the sensors that are used to record various aspects of the event.

One embodiment of the present invention uses computer vision to extract the data from the uploaded video, and then uses the timestamp metadata in the video to sequence the data from the different videos. This data is then analyzed for correlations between different data points. Various representations of the data, such as graphs or animations or other depictions, are presented to the user and any third parties, such as a coach.

Various embodiments of the present invention allow the user to input and track real-time game performance data, which can be shown in the same graphs as the training data. This allows the user to see when a training metric rises and falls over time and how it relates to the rise or fall of a performance metric.

Prior art data collection methods require a user account and subscription for each specific application, which methods do not allow the input and correlation of data from other useful applications. These methods also do not provide the user with the ability to track and compare their actual competitive performances. Various embodiments of the present invention provide an affordable alternative that provides one place for various types of data to be cross-referenced and used.

Thus, embodiments of the present system leverage a user's current sensors to be more valuable, because his data is easily overlaid with other data sets. This reduces the learning curve because additional work outside of the smartphone is not required to see a broader picture of athletic performance. The present system also allows the user to add additional data points that are not tracked by the sensors. This could be data from another sensor or user input data.

### Sensor-Centric Embodiments

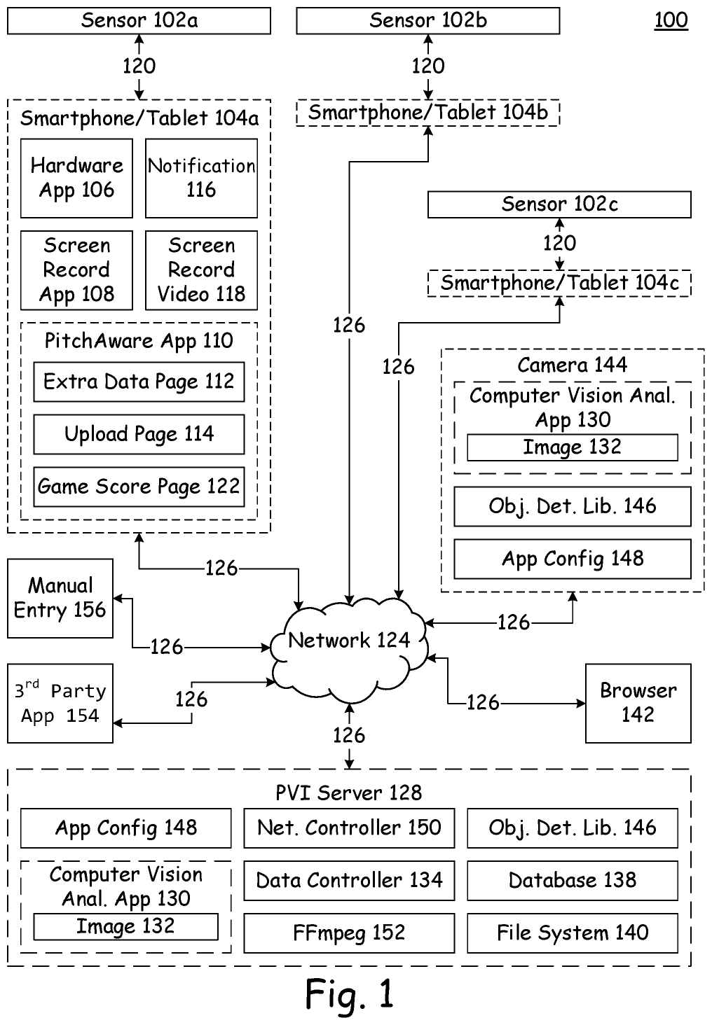

With reference now to FIG. 1, there is depicted a functional block diagram of a PVI system 100 according to an embodiment of the present invention, in which the user is a batter in a batting cage with a live pitcher throwing pitches. Three sensors are being used to track the batter's performance, although in other embodiments a different number of sensors could be used. There is a first sensor 102a on the bat to track bat speed and swing angle metrics, a sensor 102b tracking the flight of the ball from the pitcher (velocity, spin rate, x,y location, etc.), and a third sensor 102c tracking the flight of the ball after connecting with the bat (exit velocity, direction/angle, spin, etc.). These three sensors 102a,b,c are connected to three different smart devices 104a,b,c in this example, which could be two different smartphones and one tablet, for example. In other embodiments, the three sensors 102a,b,c could all be communicating with a single smartphone 104a.

Before the first pitch is thrown, the screen record feature 108 on all three devices 104 is turned on, and the user navigates to the relevant sensor application 106 so that the data is displayed on the screen of the device 104 during the activity. The pitcher starts pitching to the batter, which activity continues for some length of time. During this time a third party, such as a coach, is holding the device 104 that is connected to the sensor 102a on the bat. The software 106 for this sensor 102a presents more information than can fit on one screen of the device 104, so the coach scrolls up and down after every swing to ensure that all of the data is recorded in the video 118 that is captured by the screen record application 108.

If the coach wants to add additional data points, such as, for example, if he wants to classify the barreled value or how flush the batter's bat was with the ball on contact, the coach can use the device 104 to navigate to another application on the device 104, into which such data can be entered. One example of such other application is the PitchAware application 110, which has open the extra data page 112. For the present purposes, the embodiments described herein specifically recite the PitchAware application and PitchAware website. However, other applications could also provide the functionality of the PitchAware application and PitchAware website, as described in more detail below. The coach can then select one of the predetermined values for barreled value, for example, which the screen recording application will record.

In advance of this training session, the coach could have set up, through the PitchAware application or PitchAware website, the additional metrics that he wants to track, and the possible values of those additional metrics. Then when he navigates to the extra data page (112) in the PitchAware application, these additional metrics are already displayed. During the screen recording session, the coach can quickly swap back and forth between the sensor application 106 and the PitchAware application 110, and select the barreled value. Multiple extra data points could be added in the same manner.

Once the batting session is over, the screen recording is stopped on all three of the smartphones 104a,b,c, which automatically creates a video file 118 on each smartphone 104. The coach then opens the PitchAware application 110 on each smartphone 104, and goes to the upload page 114. On this page 114 the coach selects the video 118 to upload from the smartphone 104. The coach also enters a designation for the user and the activity.

In various embodiments, a user can perform different types of activities with the sensors 102. In this example, the batter was batting against a human pitcher, but the sensor 102a on the bat could also be used to hit baseballs off a tee, and this could be logged as a different type of activity. This flexibility allows the user and the coach to track those activities individually.

The coach then selects the upload button and the PitchAware application 110 uploads the screen recording video 118, the designation of the user, the designation of the activity, and any other relevant metadata to the PitchAware PVI server 128, such as through communication signals 126 through the Internet 124. Some of the data is stored in the database 138, and the video is stored using the file system 140. A computerized vision analysis application 130 analyzes the screen recording video 118 so as to extract all of the desired data points.

The video analyzer 130 uses a technology such as computer vision to recognize text and associated numbers in the application 106 or 110 that is recorded in the video 118. This breaks down the video 118 into a plurality of static photographic images 132. Then the computer vision program 130 extracts the text and numbers from those images 132 to create key:value pairs. The computer vision program 130 is trained to recognize the structure of certain application data screens 106, as well as the PitchAware extra data page (112) and structure. This enables the program 130 to recognize the key:value data pairs.

After the program 130 has gathered all the key:value pairs from a given image 132, it compares that set of key:value pairs with the key:value pairs that it gathered from the prior analyzed image 132. If they are all the same, then the new pairs are disregarded. If there are some keys that are the same but some keys that are not present, then the program 130 adds the new ones to the prior set of key:value pairs.

If there are keys that are the same as some keys in the last set, but the values are different, then the current set of key:values is recorded as a new set. In that case, the prior data set is stored and a new data set is started, along with the timestamp from the metadata. This also allows for the extra data to be included in each data set from the sensor application 106. This process is repeated until all the images 132 from the video 118 have been processed. Once the processing is complete, the image 132 and the payload of data sets is returned to the data controller 134 to store in the main PitchAware database 138. This data is stored in association with the identifiers for the user and the activity that was performed.

The user and coach are then notified, such as via an in-application notification 116 or an email, that all the data has been processed. Reacting to the notification 116 takes the user to either a page in the PitchAware application 110, or a page on the PitchAware website 142, with a graph that shows all of the data from the three sensors 102, where the x axis is the timestamp. The data is synced via the timestamp values for the three different sensors 102. This allows the PVI system 100 to build a complete picture of each event.

The user can filter the presented information, such as to remove specific metrics or retain only specific metric ranges. For example, the user can see, for every pitch, the pitch velocity, pitch spin rate, pitch spin direction, bat speed, swing power, time to contact of swing, swing attack angle, exit velocity of batted ball, direction of ball flight, and distance of ball flight. The software also calculates correlation coefficients between each of the metrics. This enables the user to see which metrics correlate with exit velocity, for example. The user also has access to view, edit, and add to the raw data. If he wants to add additional metrics that were not tracked during the screen recording process, he can add those after the activity by use of the web site 142.

Thereafter, when the user plays in competition, the coach can use the game scoring page 122 in the PitchAware application 110 to chart the baseball game, including entering pitch location, velocity and result.

After the user has been training consistently with the process described above, and playing in competition while using the application 110b to chart the game with the game scoring software 122, which tracks competitive performance, the coach and the user can access graphs in the PitchAware application 110 or through a web browser 142 that connects to the PitchAware PVI server 128 and database 138 that show a more macro view of the training metrics and performance metrics on the same graph. This graph shows, for example, a moving average of each metric, with the x axis being the date. This view also shows calculated correlation coefficients between training and performance metrics. This enables the user to visually perceive whether a change in a training metric or combination of metrics causes a related change in a performance metric or combination of metrics.

In another embodiment, the sensor device 102 has an internal storage for event data. Thus, a smart phone 104 doesn't need to be connected to the sensor 102 at all times, but can be connected to download the data at some point in time thereafter, such as the end of a training session or performance. In this case, the user could connect their smartphone 104 to the sensor device 102 and download the event data into the sensor application 106 on the smartphone 104. Then they can turn on the screen recording application 108 and navigate through all of the events in the application 106, making sure to look at all of the data for each event. This ensures that the video 118 created by the screen recording application 108 is recording all of the data. After stopping the screen recording application 108, the video is uploaded through the PitchAware application 110 to the PitchAware PVI server 128 for processing 130. In this case, the sensor application 106 recording of each event has a timestamp, and this timestamp is used for data syncing instead of the screen recording video 118 metadata timestamp.

In another embodiment, the user uses the extra data page (112) to select the user participating in the activity. For example, in the example of batting against a pitcher as described above, if the batter takes five swings, then leaves the at bat, and another batter takes five swings, the coach does not want to have to stop all three screen recording sessions 108 with each change of batter. In this use case, the coach can change to the PitchAware extra data page 112 on the smartphone 104 running the PitchAware application 110, and change the user designation. Then when all three data sets from the three devices 104 are synchronized at the PVI server 128, the data controller 134 uses the user designation to break up the events by user and store them in the database 138 accordingly.

The screen recording videos 118 from the sensors 102 that are tracking the incoming ball flight and the outgoing ball flight also upload with the user selection on the upload page 114. This informs the PVI server 128 upon storage of the data to look for other data that is uploaded with similar timestamps and the same activity designation, and synchronize such data streams.

In yet another embodiment, each batter has a separate sensor 102 on their bat. Thus, when they swing, a different sensor 102 records the motion. Each batter can have their own smartphone 104 connected and screen recording application 108 running. As above, their associated sensor 102 might store the swings internally for later download in the sensor application 106. In this case, each batter would be responsible for uploading, such as through screen 114, a screen recording video 118 of their swing data to the PVI server 128.

In another embodiment, the sensor device 102 is used in competition, such as a live game or a showcase type event. The event hosts want to provide the data in a semi-live environment to enhance the digital game experience. The event is using the scoring software 122 in the PitchAware application 110 to live-score the game. The athletes are using the sensor devices 102 during the game. The sensors 102 are connected live to smart devices 104 and the screen recording applications 108 are active on all the smart devices 104 during the event. Once there is a break in the action, such as a timeout or the end of an inning, the screen recordings 108 are stopped and the videos 118 are uploaded through the application 114. The screen recordings 108 are started once again as the event resumes.

In those embodiments, the sensors 102 record data internally, then during a break in the action the sensor 102 is connected to a smartphone running the application 106 and the event data is downloaded. Then the user can return to play with that same sensor 102, or can return to play with another sensor 102 that is swapped in. A screen recording video 118 is recorded on the application 106 while a user views the event data that was downloaded. When the screen recording videos 118 are upload to the PVI server 128 and the data synchronization with timestamp is completed, the data is synchronized with live event plays that are also being recorded in the PVI system 100 through the live scoring software 122. Then in the recap/play-by-play views of the live event on the web page 142, the plays are annotated with this advanced training data that is gathered and processed from the screen recording videos 118.

An example of this is next provided. The host of a baseball game would like to present the swing speed data when balls are in play. The current batter has a batting sensor 102 on his bat. The next batter puts the sensor 102 on his bat and so on. Behind home plate is a smartphone or other device 104 connected to this sensor 102 through the application 106 that is associated with the sensor 102. The score keeper who is scoring the game via the PitchAware scoring software 122 is also behind home plate. Scoring includes tracking who is batting, who is pitching, and pitch by pitch information so as to provide an online representation of what is happening during the event.

After each half-inning the scorekeeper stops the screen recording application 108 on the smartphone 104 connected to the bat sensor 102, uploads 114 the video 118 to the PitchAware PVI server 128, selects “live game” for the designation of the activity, and selects “many” for the designation of the user on the upload page 114. These settings inform the PVI server 128, when storing the processed data 134, to look for a game being charted 122 to synchronize the timestamps and to determine the user. When the data is stored in the database 138 it is attached to the same at-bat records for the live game. This allows the event metrics to be displayed along with the data tracked by the scorekeeper in the scoring software 122.

For example, the first batter gets a hit and the scorekeeper records it as a double hit in the right field gap. After the screen recording video 118 is processed at the next half-inning, when a viewer goes to the website through a web browser 142 to review that hit, they can also see the bat speed, hand speed, attack angle, and the other recorded metrics.

In another embodiment of this example of a live event, the sensor 102 can record data internally. For example, instead of just one bat sensor 102 for the entire game, every batter has their own sensor 102 when they go up to bat. At some point thereafter, they download the swing data to the sensor application 106, record the screen as they look at the data in the application 108, and upload the video 118 through the PitchAware application 110 upload page 114. The PVI server 128 can identify the uploader by the authentication credentials in the PitchAware application 110, whether the uploader is a player or a scorekeeper. In this manner, the data controller 134 is able to find the event to which the data in the database 138 should be associated.

In another embodiment of this example of a live event, the smartphone 104 connected to the bat sensor 102 live streams its screen to the PVI server 128.

In another embodiment, a GoPro camera is use as a sensor 102 to film the user during training. The GoPro 102 is either recording video onto local storage or streaming it to a PVI server 128. The locally recorded video file is uploaded to the PVI server 128 through the PitchAware application 110 or website 142. When the application 130 analyzes and breaks down the data from the screen recording videos 118 with time stamps, these time stamps are used to clip smaller swing or pitch clips from the GoPro video and attach those in the database 138 with the data set for each swing or event. Additional video sources could also be connected and clipped in the same way. This allows multiple different viewing angles to be synchronized with the data.

If a pressure plate sensor 102 is used, or some other flow device 102 that doesn't deliver a single number per metric, but instead delivers a flow of numbers throughout the movement, a screen recording 118 of that application 106 output could be used in the same way as described above. The screen recorded video 118 could be clipped and connected. After the session, when the coach and player go back to review the data, they are able to see the video clips and data sets together. They will also be able to search for and look at all the swing videos for bat speed within a selected range, for example. This provides an autonomous video and data cataloging service that enables users to see technique and output historically as well as in the short term, day to day.

If the cameras 102 are live streaming to the PVI server 128, then a user, through the PitchAware Application 110, can access the live stream video of that camera 102, back it up, and watch the past swings and make annotations on the video. If the user draws on the video and saves it, the information is stored on the PVI server 128 and added to the clipped video as well.

For example, a baseball team is taking batting practice under the direction of two coaches. One coach is pitching to the batters and the other coach is reviewing the captured data with the batters after they complete their at-bat. All the batters have Blast devices 102a on their bats, and there is a Rapsodo hitting device 102b tracking the balls hit. The Rapsodo is connected to an iPad 104b doing screen record. There are also two GoPro cameras 102 on tripods that are live-streaming the practice, one on each side of the plate so that they can track both left-handed and right-handed batters without having to move the cameras 102.

The reviewing coach is standing away from the batter that is currently at-bat, and is talking with the other batters. Once a batter finishes batting, he goes over to see the reviewing coach. The coach opens the PitchAware application 110 on his phone or tablet 104, and reviews with the batter the captured video of his swings. They can slow down the video, draw on them, and so forth as described elsewhere herein. The batter can thereafter use his own phone 104 to download his Blast data to his phone 104, screen record 108 the data in the Blast application 106, and upload the screen recording 118 through the PitchAware application 110. Once the PitchAware PVI server 128 has completed processing the data and cutting up the video, it sends the batter a notice 116 on his phone 104. At this point, the batter can go back into the program and look at each swing and the data from the Blast device 102 for each swing. The coach can compare this information with past videos and data.

After batting practice, the coach stops the screen recording 108 for the Rapsodo 102 and uploads it through the PitchAware application 110. This data is also added to the swing event data. When the coaches or players look at the data at a later time, they are able to see the video for each swing along with both the Blast and the Rapsodo data, and any drawings that were done on those videos. The coaches and players are able to filter and sort the videos.

Utilizing computer vision technology 130, the PVI server 128 and the software applications can be taught to recognize the different types of activities and the user (facial recognition) that are recorded in the video. This allows the user to skip the selection of the user and activity on the Upload Page 114 in the PitchAware application 110 when uploading screen recording videos 118 when video is also recorded and the video is connected to the PVI system 100 either via upload or live stream. If the PVI server 128 recognizes when a batter is hitting off a tee versus hitting a thrown ball, the user can screen record 108 a long, continuous session and not have to break up the screen recording video 118 by activity.

For example, if a batter is taking a batting lesson, he might hit ten balls off the tee, then ten soft tosses, then ten more off the tee. Without the video, batting data from the Blast device 102 on the bat would have to be uploaded in three separate screen recording videos 118, or in one video if the user goes into the web site and alters the data after the fact so as to differentiate those swings that were from the tee and those that were soft tosses.

However, if in this embodiment a camera is recording, when the PVI server 128 processes the video it could distinguish that in the first ten swings the batter was hitting the ball off of a tee, then in the next ten swings the batter was hitting a ball tossed to them, and then in the next ten swings it was off the tee once again. When the data controller 134 connects the Blast data from the screen recording video 118 of all thirty swings with the video clips from the camera, it will update the activity based on the analysis of the video. Adding to this, if the PVI server 128 and its software has been taught to recognize the user, the batter can be swapped out and the user does not have to directly identify the change, either through the extra data page 112 for the screen recording, or by uploading multiple screen recording videos 118.

In another embodiment, other data streams for the event can be added through either CSV files or API access. The CSV file could be upload to the PVI server 128 through a web browser 142 by the user or through the upload page 114 in the application. The PVI server 128 could also receive a data payload from another server. These data files would then be connected by the data controller 134 by time stamps and stored in the database 138. The user could then view this data along with all the other data collected and see its correlations as well.

In another embodiment, the duration between data sets or events could be less than a second, for example if the data was gathered from a heart rate monitor that sampled every half second. Then, when connected with a video source, the user would be able to view the video across multiple data sets through the web browser 142. For example, the user could be looking at moments in which the heart rate climbed to a specific level, then the user would be taken to the matching timestamp location in the video and be able to watch forward from that point, or go back in the video from that point.

### Video-Centric Embodiments

In some embodiment, the PVI server 128 contains a library 146 where different visual detector objects, such as trained TensorFlow Object Detectors, are available. Users can train their own detector objects and add them to the library 146, or use the objects provided with the library 146. Each object detector is configured to detect specific data fields in the dashboard.

When a user wants to build an application using the PVI server 128, he uses the application configuration software 148. This can be accessed either via a web browser 142 or an application programming interface API, which is accessible through the network controller 150. To configure the custom PVI application 148, the user selects a number of supported dashes from the object detector library 146. For each added dash, the user can select any of the supported data fields in that dash. For example, the dash may gather pitch velocity, spin rate, and tilt, but for this specific application, the user is only interested in pitch velocity and spin rate. Then each dash can be configured to update the event log in the database 138, either by detecting a change in a given field value, or by a desired data sampling rate, such as in fractions of a second, where the PVI server 128 adds data to the event data log as a new row every sampling rate segment, while the dash is recognized by the computer vision analysis application 130.

Once the supported dashes are added to the custom application configuration 148, the user can start sending video sources 144 to the PVI server 128 via the network 124. The created application 148 is associated with a unique identifier that allows the user to connect via an API interface 150 to the PVI server 128, as desired. Then the video files 144 or live streaming of video is passed to the PVI server 128 with the app ID and the object ID for that video information. The computer vision analysis application 130 breaks the video source down into individual images 132. It then runs the image through the object detectors from the library 146 that are attached to this specific custom application, as identified by the app ID.

In various embodiments, one or more of the computer vision analysis application 130, object detection library 146, and application configuration routine 148 are resident in the camera 144, which reduces the bandwidth required to send information from the camera 144 to the PVI server 128. Further, one or more of the computer vision analysis application 130, object detection library 146, and application configuration routine 148 can also be resident in the smartphone 104, which reduces the bandwidth required in those embodiments as well.

In other embodiments, the camera 144 sends a video stream to the PVI server 128, and such functions are handled by the PVI server 128. In the former embodiments, smarter cameras 144 are required, but lower bandwidth is needed. In the latter embodiments, standard cameras 144 can be used, but great bandwidth in needed. Different divisions of these modules between the camera 144 and the PVI server 128 are also comprehended.

If a match is found, the computer vision analysis application 130 passes the extracted data with the timestamp from the video, dash identifier, app ID, and object ID to the data controller 134. The data controller 134 then looks up the configuration for this dash, which tells the data controller 134 what data points to store, and whether to store the data points based on a change of data or based on a sampling rate of the data. The data controller 134 determines if the data so extracted should be stored in the event data log in the database 138. If the data is to be stored, the data controller 134 compares the timestamp with other timestamps in the event data log.

If there is a match, then this data in added to the row. If there is no timestamp match, then a new row is added. In some embodiments, the timestamp comparisons include a time range in which two timestamps are considered to be matching. The object ID is also stored in the event data log with the extracted data. The image from which the data was extracted is also stored in the file system 140 for later review, or to be used later to further train the object detector.

The user can deliver multiple video files 144 or live streams to a custom application on the PVI server 128 either concurrently or at different times using the same object ID, which is user-defined. When this is done, the PVI server 128 merges all of the data that is associate with a given object ID and app ID into a single data set in the database 138, sorted by timestamp. A PVI application 148 can handle any desired number of dashes and video sources 144.

The two primary use cases for the object ID provide by the user is either as a user ID or a session ID. The user ID is primarily used if there is a single user that is being tracked by all of the video sources 144. The session ID is designed for group training sessions, where multiple users are tracked by the video sources 144.

The PVI system 100 has API support for various applications through the network controller 150, so as to enable manual data input 156 to the event log. For example, for a given session ID, the video sources 144 can include multiple hardware devices 102 that are tracking batting practice for a baseball team. Multiple athletes are involved in the session, with each athlete hitting several balls, one athlete after another, and with data being tracked on the dashes. In this situation, the videos need to continue to flow with the same object ID, as it is not conducive to the training to stop and start the video for each new hitter.

For this embodiment, the PVI system 100 allows the user to manually enter data 156, such as user ID, with the same app ID and object ID. This allows for the user to attach each event data row with a specific user ID. The user can either send the manual data entry 156 through a web browser 142 connected over the network 124 to the PVI server 128 and a custom PVI application 148, or API support could be built into the PitchAware application 110 that delivers the data. The network controller 150 bypasses the computer vision analysis application 130 when data is manually entered, and sends it directly to the data controller 134, along with the timestamp, app ID, and object ID. The data controller 134 uses the same logic for matching timestamps as described above to merge the data into the event data log in the database 138.

The user can also send custom data fields for a specific app ID and object ID. Each custom data field has a repeat flag that is set to either false (default) or true. If the repeat flag is set to true, then every new event data row after the custom data field was sent inherits the last value for that custom data field. This allows the user to send the user ID only once per hitter, such as when the hitter changes. Then that user ID stays the same until the user sends a new user ID, signifying a change in the hitter.

The use case for setting the repeat flag to false is when the user is also sending data that is not being tracked by the devices 102 or the video sources 144, such as, for example, when the hitters are using metal bats for some swings and wooden bats for others. The user could send this data as well. The data controller 134, when merging the data that is received from the computer vision analysis application 130, reviews the last submitted custom data from the user and the status of the repeat flag. If the repeat flag is true, then the data controller 134 copies the last data for the custom fields and stores it in the event data log in the database 138.

The PVI system 100 allows the user to deliver live video sources 144 to the same app ID and object ID. The live video 144 is of the user performing the activity and being tracked by the sensors 102. In the initial application configuration 148, the user can set a live clip cut window with a start and end in seconds. This will start the clip at the start number of seconds before the event data row timestamp, and end the clip at the end number of seconds. For example, in the batting practice described above, if the start is 4 and the end is 6, then the clip will be 10 seconds in length and start 4 seconds before the timestamp. The start and stop windows can also be overridden via the API when the video source is delivered to the PVI server 138.

When the live video sources 144 are received by the network controller 150, they bypass the computer vision application 130, and the video stream is stored in the file system 140. When the data controller 134 determines that the event data log needs to be updated with the data it receives, it checks to see if the app ID and object ID combination have any live video sources 144. If they do, the data controller 134 accesses the application configuration 148 for the video clip duration parameters and overlay information. It then passes this to the FFmpeg 152 application (or other application with similar functionality) that constructs the proper commands to have the FFmpeg 152 software library create the clip.

The PVI system 100 is designed to allow third party application 154 to gather and use data. These applications 154 can access event data logs in the database 138 by querying the database 138 through the API interface 150 by one or more of app ID and object ID. Some of these embodiments are described below.

### Education

Students that are schooling at home through a unified school district typically do reading assignments using one application, math with another, and so forth. The teachers have to log into multiple sites to view the students' progress.

With the PVI system 100, an app developer provides a trained object detector to the object detector library 146. Alternatively, anyone with proper access to the PVI system 128 can create a trained object detector and add it to the object detector library 146. Then, an application 148 is created in the PVI system 100 with the supported app dashes for that school district or class. For this example, the application 148 is called Class 3. The students install the required software on their computers, which connects with the PVI server 128. For this example, this software is called Grade 6. When the student starts a session, he opens the Grade 6 software, selects the Class 3 PVI application, and enters his student ID (object ID). A live stream of his computer screen starts.

The student navigates to the apps he is supposed to use for his work. He completes his tasks while the PVI server 128 is processing the video and looking for the supported dashes attached to this application. When the PVI server 128 sees a dash, it logs the information. The school district can configure the PVI application 148 to provide the event log data to either their own application, Sales Force, an Excel file, or Google sheet, for example.

In another embodiment, the user's computer 104 has one or more of the computer vision analysis application 130, object detection library 146, and application configuration routine 148 components installed, allowing the data to be extracted from the video dashes on the user's computer 104, thereby saving bandwidth by only sending data to the PVI server 128 instead of streaming video. This would be a significant bandwidth saving on the school's network if all of the classes in a school building were using this application.

In the example above, support for the workflow comes from the school district administration. In an API regime, the school would rely upon the app developers for updates, support and structure of API calls, and data provided. With the PVI regime described herein, the school trains the object detectors as needed, and provides the students with an application to connect to the PVI server 128 and API controller 150. This greatly increases the success of the school program, and allows the school system to select whatever teaching applications they would like to use.

A live video source 144 can also come from the camera on the device that views the student. The application can be configured to save an image from the live source for each entry in the event data log. This can be used to verify who was doing the work.

The PVI system 100 enables education technology providers to innovate by connecting data and gathering insights. Companies like ClassDojo, which already have relationships with school districts, can benefit from use of the PVI system 100 by integrating the PVI system 100 into their applications. They can create object detectors for virtually every education application. A teacher schedules class time for their students through ClassDojo. The students get the class time notification through their ClassDojo app and see what they are to do. The class is started through the ClassDojo app, which connects with the network controller 150 to start the video stream and pass the appropriate app ID and object IDs. ClassDojo accesses the event data log after the class is completed, performs analyses, and provides teachers and administrators with desired metrics.

In another embodiment, the computer vision analysis application 130, object detection library 146, and application configuration routine 148 components are provided in a software development kit (SDK) that ClassDojo or any other App developer could build into their applications so as to make use of the PVI system 100 and connect with the PVI server 128. Using the SDK, application developers connect to the PVI server 128 to download the object detector 146 and application configuration data to reduce the bandwidth by extracting the data from the screen record video 118 locally on the device in their application, and then deliver the event data to the PVI server 128 through the SDK.

### Healthcare

As introduced above, the PVI system 100 supports use of a camera that is positioned to record any display. Hospitals have many devices that track a variety of metrics on patients. Each type of device is typically found with many different versions, each a little different from the other. It can be challenging to get all of the devices with their various versions to communicate with the nurses' station and continually monitor the information that they provide.

However, such devices typically have a display. A camera 144 can be positioned to record one or many such displays. This same camera 144 can also be used as a live video source, connected to the Internet, and in communication with the PVI server 128. Using the PVI API 150, the camera 144 is connected to an object ID. The object ID can be a hospital room, for example, or using the session ID model described above, the object ID can be the camera ID. The hospital can develop their own application 148 to use the object ID to attach the patient value to the event data log export. The PVI system 100 allows hospitals to own and control the entire process of connecting the hardware in a seamless data system. The hospital technicians position the cameras and the PVI system 100 gathers the data.

The PVI system 100 can also provide DVR functionality, where the user or administrator wants to go back in time and watch the video starting at an event timestamp.

In the initial PVI application configuration 148, when adding support for a live video source, the user adds data overlay support to the video. The user is presented with all the fields available in the supported dashes that have been selected. They can also add custom fields. If the user adds custom data with the custom field name, then that field value is overlaid for that event video.

For both the healthcare and education applications in particular, the object detector library 146 and the app config 148 are, in one embodiment, resident in an application on either a smartphone or computer 104. The PVI server 128 is provided to these users as a platform as a service (PaaS), where third party developers can use the provided SDKs to build the PVI system 100 into their applications. Other developers can similarly build any application they desire using the PVI PaaS 128. Processing the video 118 on the device that is recording the video (such as a smartphone or computer 104) improves the ability of the PVI server 128 to handle more users.

### Hardware Platform

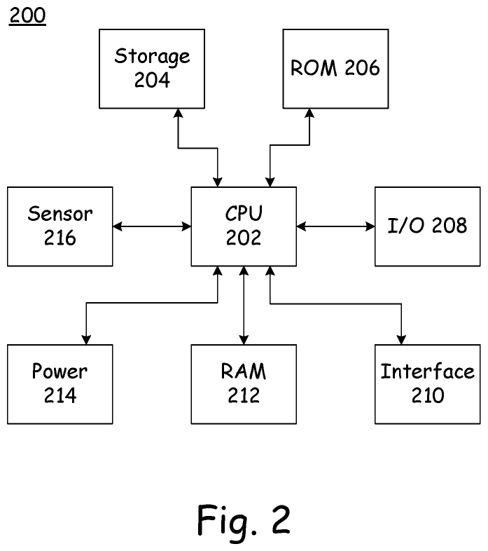

With reference now to FIG. 2, there is depicted one embodiment of a computerized apparatus 200 capable of performing the actions as described herein. In this embodiment, the apparatus 200 is locally under the control of the central processing unit 202, which controls and utilizes the other modules of the apparatus 200 as described herein. As used herein, the word module refers to a combination of both software and hardware that performs one or more designated function. Thus, in different embodiments, various modules might share elements of the hardware as described herein, and in some embodiments might also share portions of the software that interact with the hardware.

The embodiment of apparatus 200 as depicted in FIG. 2 includes, for example, a storage module 204 such as a hard drive, tape drive, optical drive, or some other relatively long-term data storage device. A read-only memory module 206 contains, for example, basic operating instructions for the operation of the apparatus 200. An input-output module 208 provides a gateway for the communication of data and instructions between the apparatus 200 and other computing devices, networks, or data storage modules. An interface module 210 includes, for example, keyboards, speakers, microphones, cameras, displays, mice, and touchpads, and provides means by which the engineer can observe and control the operation of the apparatus 200.

A random-access memory module 212 provides short-term storage for data that is being buffered, analyzed, or manipulated and programming instructions for the operation of the apparatus 200. A power module 214 is also provided in various embodiments of the apparatus 200. In some embodiment that power module 214 is a portable power supply, such as one or more batteries. In some embodiments the power module 214 includes a renewable source, such as a solar panel or an inductive coil that are configured to provide power or recharge the batteries. In other embodiments the power module 214 receives power from an external power source, such as a 110/220 volt supply.

Some embodiments of the apparatus 200 include a sensor 216, which senses at least one of various aspects of the motion or condition of the user, and the outcome of the motion. In some embodiments the steps of the method as described herein are embodied in a computer language on a non-transitory medium that is readable by the apparatus 200 of FIG. 2, and that enables the apparatus 200 to implement the process as described herein.

The foregoing description of embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A method for correlating performance data in regard to a performance of a user, the method comprising the steps of:
capturing a first data stream in regard to the performance on a first device,
capturing a second data stream in regard to the performance on a second device,
uploading a first video of the first data stream to a correlation device,
uploading a second video of the second data stream to the correlation device,
using machine vision on the correlation device, extracting first performance data from the first video, and extracting second performance data from the second video,
associating the first performance data with the second performance data to create correlated performance data on the correlation device, and
enabling access to the correlated performance data to authorized users on the correlation device.

2. The method of claim 1, wherein at least one of the first data stream and the second data stream comprises a video of the performance.

3. The method of claim 1, wherein at least one of the first data stream and the second data stream comprises telemetry in regard to objects with which the user interacts during the performance.

4. The method of claim 1, wherein at least one of the first data stream and the second data stream comprises physiological data in regard to the user during the performance.

5. The method of claim 1, wherein at least one of the first data stream and the second data stream comprises at least one of bat speed, bat arc, and bat angle.

6. The method of claim 1, wherein at least one of the first data stream and the second data stream comprises at least one of ball speed, ball rotation, and ball trajectory.

7. A method for capturing performance data in regard to a performance of a user, the method comprising the steps of:
displaying a first data stream in regard to the performance on a first device,
capturing in a first video the display of the first data stream,
uploading the first video to a correlation device,
using machine vision on the correlation device, extracting first performance data from the first video, and
enabling access to the first performance data to authorized users on the correlation device.

8. The method of claim 7, wherein the first data stream comprises telemetry in regard to objects with which the user interacts during the performance.

9. The method of claim 7, wherein the first data stream comprises physiological data in regard to the user during the performance.

10. The method of claim 7, wherein the first data stream comprises at least one of bat speed, bat arc, and bat angle.

11. The method of claim 7, wherein the first data stream comprises at least one of ball speed, ball rotation, and ball trajectory.

12. A method for capturing performance data in regard to a performance of a user, the method comprising the steps of:
displaying a first data stream in regard to the performance on a first device,
capturing in a first video the display of the first data stream,
using machine vision, extracting first performance data from the first video,
uploading the first performance data to a PVI server, and
enabling access to the first performance data to authorized users on the PVI server.

13. The method of claim 12, wherein the first data stream comprises physiological data in regard to the user.

14. The method of claim 12, wherein the first data stream comprises educational data in regard to the user.
